(19) United States
(12) Patent Application Publication
(10) Pub. No.: US 2021/0334721 A1
(43) Pub. Date: Oct. 28, 2021

(54) APPLICATION ENVIRONMENTS FOR ORGANIZING INFORMATION AROUND SPACES AND GOALS

(71) Applicant: Microsoft Technology Licensing, LLC, Redmond, WA (US)

(72) Inventors: Elizabeth Marie Parker, Bellevue, WA (US); Bradley James Demirjian, Tokyo (JP); Joseph Patrick Masterson, Issaquah, WA (US); Mirela Dal Col Silva Correa, Kirkland, WA (US); Andrew Wen-Shien Hwang, Bellevue, WA (US); Fabio Andre Pintos, Kirkland, WA (US); John Charles Lorenz, Bellevue, WA (US); Teslim Abiodun Alabi, Redmond, WA (US); Eva Britta Karolina Burlin, Cambridge (GB); Ian Dwyer Curry, Seattle, WA (US)

(21) Appl. No.: 16/916,710

(22) Filed: Jun. 30, 2020

Related U.S. Application Data
(60) Provisional application No. 63/016,109, filed on Apr. 27, 2020.

(51) Int. Cl. G06Q 10/06; G06F 9/451

(52) U.S. Cl. CPC G06Q 10/06313; G06F 9/451

(57) ABSTRACT

Systems, methods, and software are disclosed herein. A method comprises a computing apparatus displaying, in an application environment, a canvas on which to organize a collection of items on the canvas that are related to a project. The method includes the computing apparatus displaying a new item on the canvas comprising a goal associated with the project and having attributes associated with one or more items native to one or more other application environments. The method also includes the computing apparatus sending one or more requests to express, in the one or more other application environments, an association of the one or more items with the goal.

### RELATED APPLICATIONS

This application is related to—and claims the benefit of priority to —U.S. Application No. 63/016,109, filed on Apr. 27, 2020, and entitled APPLICATION ENVIRONMENTS FOR ORGANIZING INFORMATION AROUND SPACES AND GOALS, which is hereby incorporated by reference in its entirety.

### TECHNICAL BACKGROUND

A variety of application environments provide the ability for users to organize information, but so many have proliferated that users are inundated with information in the wrong place and at the wrong time. Email applications organize email wonderfully but can still be difficult to search. Similarly, electronic calendars serve their purpose well but can become overwhelming just like email.

The list of application environments that succeed in many respects but that fail as a whole is lengthy. Each application has its strengths and weaknesses, which can be amplified by the sheer volume of information flowing at users today. Project management applications, note-taking applications, and other such environments have attempted to square the circle of organizing disparate types of information in one single location, but to no avail. Even those solutions can be too bewilderingly complex for widespread adoption.

### OVERVIEW

Technology disclosed herein relates to enhanced application environments for organizing information around spaces and goals. In various implementations, users in the context of a project space may collect items on a canvas in an application environment. A new item pertaining to a goal may then be created and attributes of the item configured to be associated with one or more other items in other application environments. The association between the goal and the other items may thus be expressed in the context of the other application environments.

In some implementations, the one or more requests each include information allowing the one or more items to link back to the new item from within the one or more other application environments. An example of a first attribute of the attributes comprises a deadline for the goal and an example of a first item, of the one or more items, may be an event scheduled in a calendar at a date and time of the deadline. A first request of the one or more requests may comprise a request to schedule the event in the calendar at the date and time of the deadline.

In various implementations, a second attribute of the new item may comprise a reference to a one of the collection of items on the canvas, and wherein the wherein the one of the collection of items comprises a link to a document object. A second request may comprise a request to populate the document object with a reference to the goal.

In the same or other implementations, a third attribute of the new item may comprise a reference to a different one of the collection of items on the canvas, wherein the wherein the different one of the collection of items comprises a link to an email object. A third request, of the one or more requests, may comprise a request to associate the email object with the goal.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, like reference numerals in the drawings designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a process in an implementation.

FIG. 3 illustrates a computing system in an implementation.

FIG. 4 illustrates a view in a personal information management application in an implementation, from where an application environment can be launched.

FIG. 5 illustrates an application environment in an implementation.

FIG. 6 illustrates a dialog box of an application environment in an implementation.

FIG. 7 illustrates an application environment in an implementation.

FIG. 8 illustrates various timeline views in an implementation.

FIG. 9 illustrates an operational scenario in an implementation.

FIG. 10 illustrates various connector features in an implementation.

FIG. 11 illustrates an application environment in an implementation.

FIG. 12 illustrates a goal item in an implementation.

FIG. 13 illustrates a view in a calendar application environment and a goal represented in the view as an all-day appointment.

### DETAILED DESCRIPTION

Systems, methods, and software disclosed herein relate to application environments that enable users to organize their information in the context of project spaces and goals. People's time has become increasingly fragmented. In addition to the chaos of daily life, people have specific undertakings that they want to put energy toward like projects for work, planning a wedding, travelling, or learning a new language. Artifacts from these activities are intermingled and spread across a number of different applications, creating unmanageable silos where messages, document comments, notes, tasks, and events pile up and create anxiety. Even if managed well, the cost of constantly switching between so many tools saps productivity.

To address this problem, the application environments disclosed herein help users work the way they think by bringing disparate information together into goal-oriented views and surfacing important information. Project spaces help people focus on achieving their goals without the stress of switching applications or worrying about what is piling up in the absence of their continuous attention.

In the various implementations disclosed herein, a computing system includes computing hardware, software, and/or firmware components configured to support the enhanced project spaces contemplated herein. In operation, the system displays an application environment comprising a canvas on which to organize a collection of items on the canvas that are related to a project space. In some implementations, the system may be capable of searching for and displaying a collection of suggested items to add to the collection of items on the canvas.

The system also displays a new item on the canvas comprising a goal associated with the project space and configures one or more attributes of the new item to be associated with one or more items native to one or more other application environments. This system may send one or more requests to express, in the one or more other application environments, an association of the one or more items with the goal.

The one or more requests may each include information allowing the one or more items to link back to the new item from within the one or more other application environments. The attributes may include a deadline for the goal and the items may include an event scheduled in a calendar at a date and time of the deadline. In addition, in some examples the requests may include a request to schedule the event in the calendar in accordance with the date and time of the deadline.

Additional examples of the attributes include references to one or more of the collection of items on the canvas such as a link to a document object and/or a link to an email object. Additional examples of the requests include a request to populate the document object with a reference to the goal and/or a request to associate the email object with the goal.

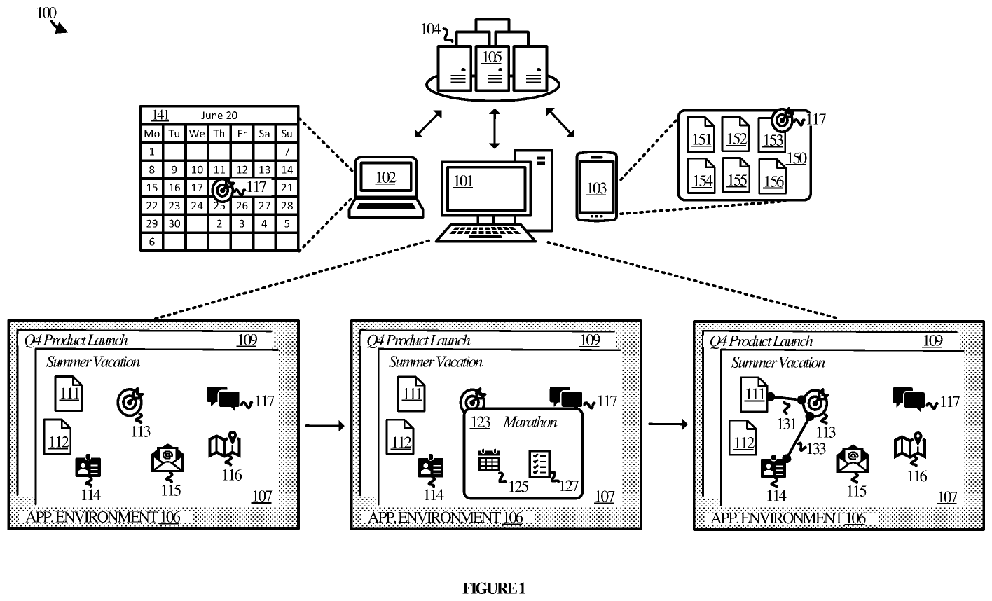

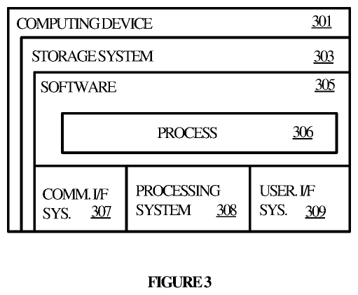

Referring now to the drawings, FIG. 1 illustrates an operational environment 100 in an implementation that confers some or all of the technical effects and other such benefits discussed above. Operational environment 100 includes various computing devices, of which device 101, device 102, and device 103 are representative. Operational environment 100 also includes one or more services hosted in a data center, represented by service 104 and data center 105. Examples of computing devices 101, 102, and 103 include—but are not limited to—mobile phones, tablet computers, laptop computers, desktop computers, wearable devices (e.g. watches), and any other computing devices, combination of devices, or variation thereof. Each of the computing devices 101, 102, and 103 may be implemented in accordance with any suitable computing architecture of which the architecture of computing device 301 in FIG. 3 is representative.

Computing device 101 includes one or more user interface devices, systems, or sub-systems through which a user may interact with software applications. Application environment 106 is representative of an environment produced by such an application when executed computing device 101. Similarly, computing device 102 produces application environment 141 and computing device 103 produces application environment 150. It may be appreciated that application environments 106, 141, and 150 differ relative to each other.

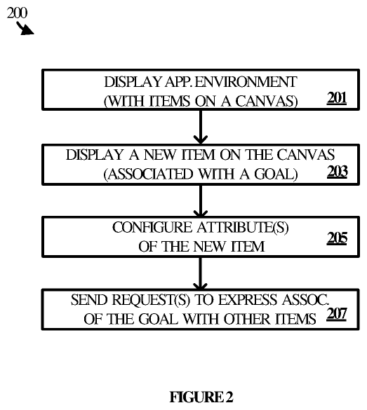

In order to provide the enhanced application environments discussed above, a computing device employs process 200, illustrated in FIG. 2. Process 200 may be implemented in program instructions in the context of any of the components, modules, or other such elements that comprise a software application that produces an application environment. The program instructions direct their host computing system(s) to operate as described for process 200, referring parenthetically to the steps in FIG. 2.

To begin, the computing device displays an application environment comprising a canvas on which to organize a collection of items on the canvas that are related to a project space (step 201). Next, the computing device displays a new item on the canvas comprising a goal associated with the project space (step 203). The device then configures one or more attributes of the new item to be associated with one or more items native to one or more other application environments (step 205). Having configured the new item, the computing device sends one or more requests to express, in the one or more other application environments, an association of the one or more items with the goal (step 207).

In some implementations, the one or more requests each include information allowing the one or more items to link back to the new item from within the one or more other application environments. An example of an attribute is a deadline for the goal, while an example of the item native to another application environment comprises an event scheduled in a calendar at a date and time of the deadline. An example request may be a request to schedule the event in the calendar in accordance with the date and time of the deadline.

In the same or other implementations, an example of an attribute comprises a reference to a one of the collection of items on the canvas and an example of the collection of items comprises a link (uniform resource locator) to a document object. Another example of a request comprises a request to populate the document object with a reference to the goal.

In still other implementations, an attribute may comprise a reference to a different one of the collection of items on the canvas. In addition, the different one of the collection of items comprises a link to an email object, in which case a request may be a request to associate the email object with the goal.

Various implementations may also include a search tool for searching for and displaying a collection of suggested items to add to the collection of items on the canvas.

Referring back to FIG. 1, operational environment 100 illustrates an exemplary application of process 200 by computing device 101. In operation, computing device 101 displays application environment 106. Application environment 106 may comprise a user interface to an application or a module of an application. For example, application environment 106 may be one component of a larger application or it may be a stand-alone application.

Application environment 106 includes various project spaces represented by project space 107 and project space 109. Each project space is associated with a different project (e.g. summer vacation and Q4 product launch) and includes a canvas on which to organize information items. In this example, project space 107 includes items 111-117, which comprises icons linked to objects native to other application environments.

For example, item 111 and item 112 are file icons that link to document objects native to a word processing application environment. Item 114 is a contact icon that links to a contact in a contacts management program. Item 115 is an email icon that links to an email object in an email mailbox and item 116 is a map icon that links to a location in a map database.

The items also include, notably, an item 113 (or new item) placed on the canvas when creating a goal for the project associated with the project space. Item 113 can be configured in a variety of ways include via menu 123. Menu 123 allows a user to set a deadline for the goal via a calendar feature 125, as well as to create tasks associated with the goal via a task feature 127. The user can also create associations between the item 113 and other items on the canvas. For instance, the user may draw a connection 131 between item 113 and item 111, as well as a connection 133 between item 113 and item 114.

Configuring item 113 via menu 123 and via connections 131 and 133 are examples of two ways in which attributes of item 113 may be configured. Computing device 101 then communicates the attributes to service 104 and, where appropriate, service 104 communicates aspects of the attributes to other application environments—potentially running on other computing devices (although not limited to such situations).

The association between item 113 and the other items (111 and 114) may be expressed in the other application environments. Likewise, the attributes of item 113 configured via menu 123 may also be expressed in the other application environments. For example, application environment 141 includes a goal icon 117 displayed in association with the date set for a deadline in menu 123. This indicates to a user that the date of June 18^{th} is associated with a goal set by the user.

As another example, application environment 150 includes a goal icon 117 displayed in association with file icon 153. This indicates to a user that the file represented by file icon 153 is associated with a goal set by the user. In contrast, file icons 151, 152, 154, 155, and 156 have no such associated goal.

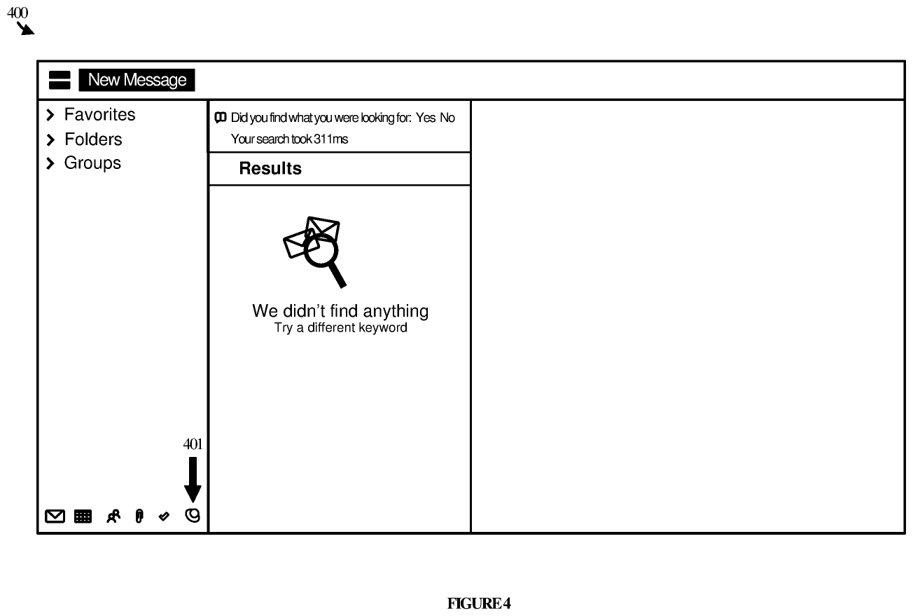

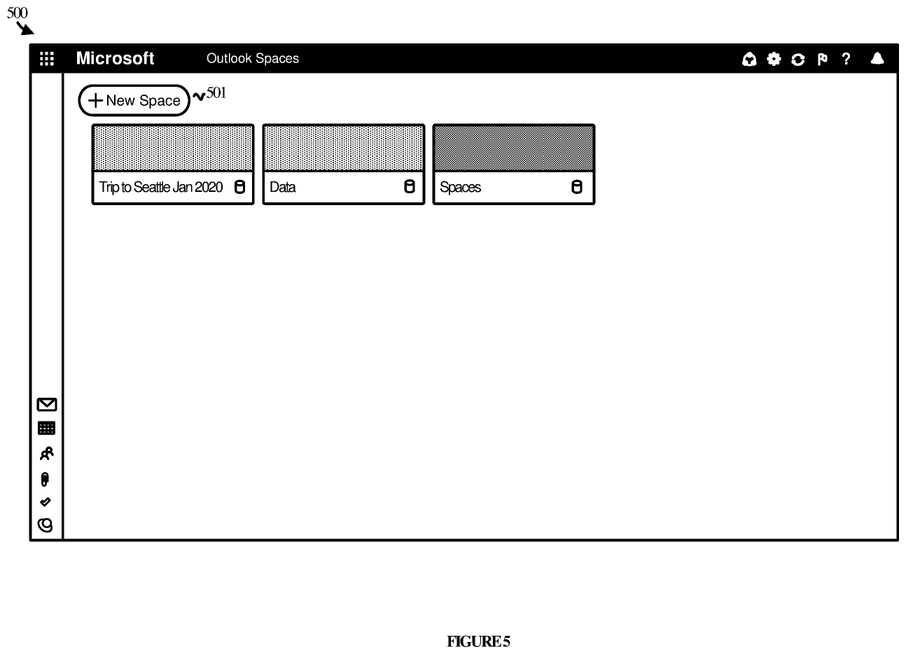

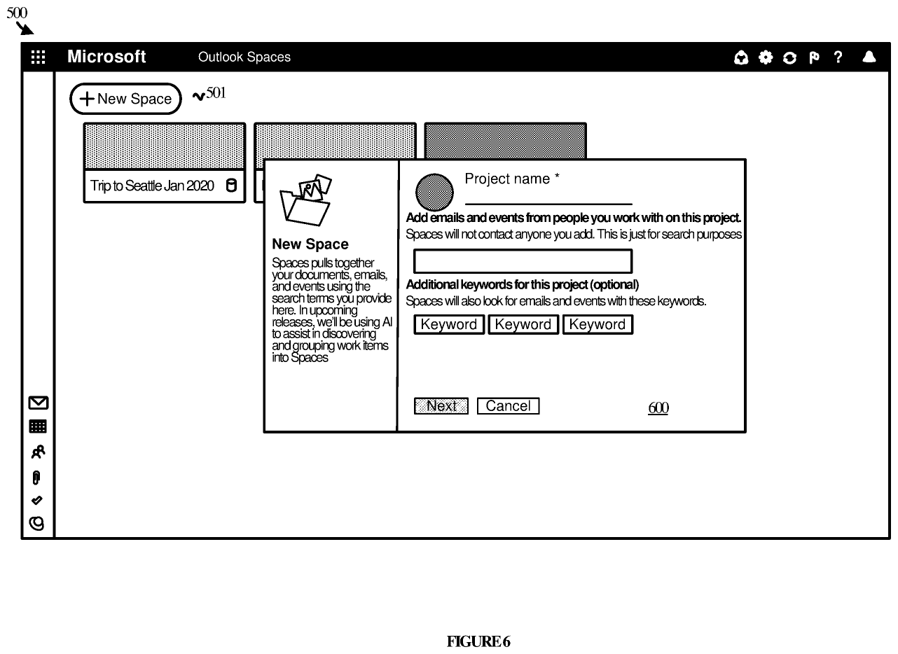

FIG. 4 illustrates an exemplary view 400 from where an application environment can be launched. In this example, the application environment can be launched by clicking on an icon 401 in a launch bar of a personal information management application. Launching the application results in a view 500 of a main landing page illustrated in FIG. 5. Users can access their existing project spaces or create new spaces. Clicking the “New Space” button 501 illustrated in FIG. 5 opens the dialog box 600 illustrated in FIG. 6. The dialog box 600 is where users provide a project name, people associated to the space, and keywords associated to the Space. The latter two may be used to automatically populate content that is related to the Space.

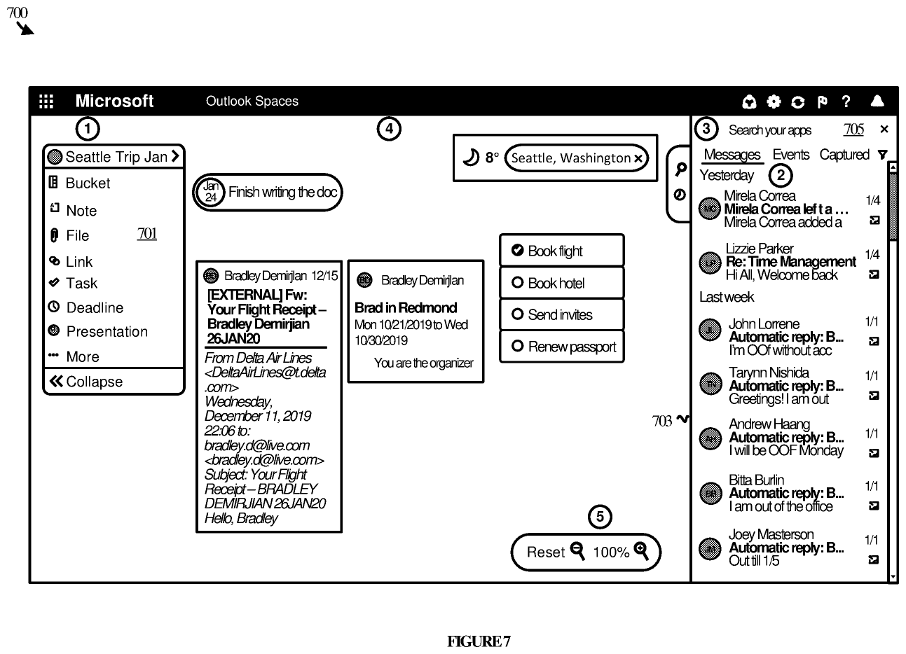

FIG. 7 illustrates an example operating environment 700 in another implementation. Operating environment 700 includes a toolbox 701 on the left side with controls that can be used to create new items on the canvas by dragging the icon for a given control onto the canvas.

A search pane 703 on the right side is populated with content related to the project space. The content may be identified based on keywords provided by a user when creating the project space, derived from existing content on the canvas, or the like.

Users may also enter keywords into a search box 705 to find other existing messages and events either in the project space, in another project space, or in other native environments such as their mailbox, document repository, or messaging application. Search results may be supplied directly from their native environments. For example, relevant emails or events could be pulled directly from a user's mailbox and deposited on the canvas.

Items may be placed and moved around freely on the canvas. A wide variety of items may be pinned such as emails, events, links, tasks, weather data, notes, and files. Other features not shown in FIG. 7 include the ability to drop time-bound assets onto a timeline view, create and edit documents, pin messaging conversations to a project space, and group content into buckets.

Some implementations may incorporate machine learning and artificial intelligence services to discover content related to a project, a trip, or the like. Collecting and pinning information items may be a two-way experience. That is, not only can information items discovered by a search within a project space be pinned to the canvas, but items can also be pinned from within their native environments onto the canvas. For example, a team chat could be pinned from within a conversation application onto a canvas of a project space. Similarly, an email or event could be pinned from within an email application to a project canvas. A document or spreadsheet could also be pinned directly from within a productivity application onto the canvas of a project space. The information contained within pinned items could also be viewed from within a project space. For instance, flight information could be summarized and displayed within a project space, rather than just the title of an email reporting the confirmation of the flight purchase. It may be appreciated that all of the aforementioned features and other such aspects may be provided in any form factor such as a desktop format and a mobile format.

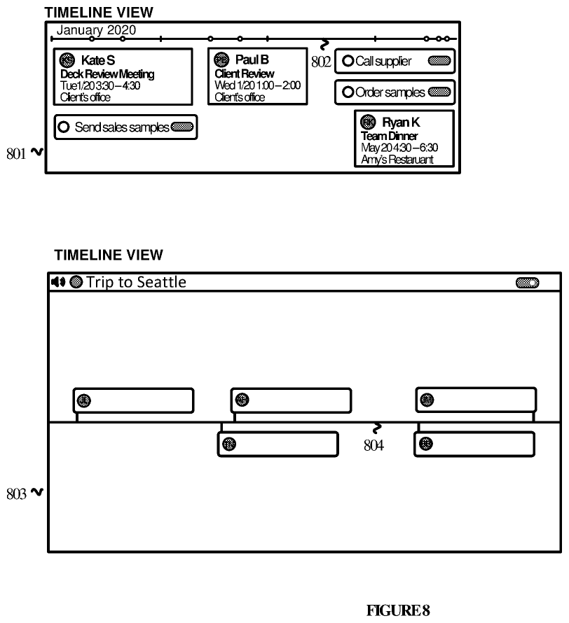

FIG. 8 illustrates exemplary timeline views of assets dropped onto a canvas in a project space that have a time component. In timeline view 801 and timeline view 803, the application environment automatically examines assets on the canvas to determine if they have a time component. Examples include calendar events, task deadlines, emails with flight confirmations, and so on. The environment automatically organizes the assets along timelines 802 and 803 so that a user can easily view the assets in terms of their time and date components. The perspective of the timeline could also be changed from a date-due perspective to a date-created perspective, or any other perspective for that matter.

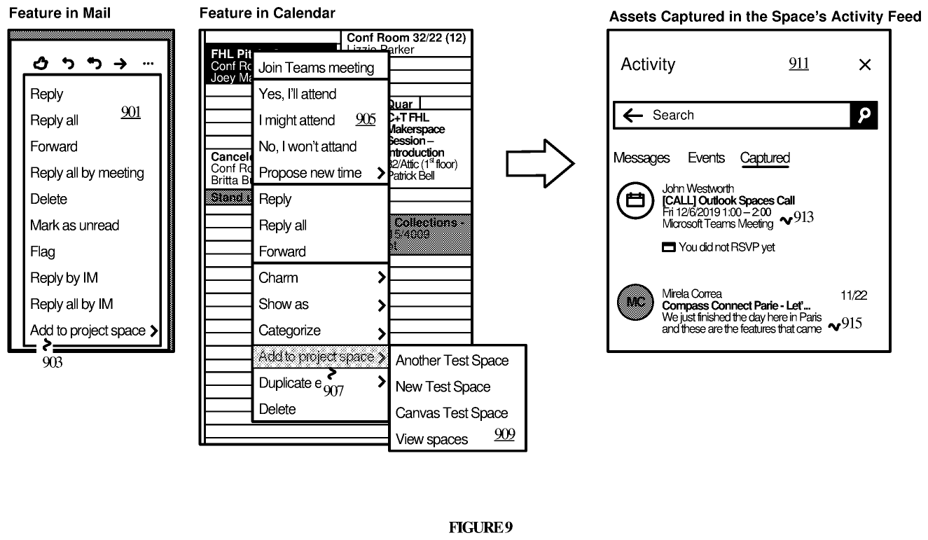

FIG. 9 illustrates a feature whereby users can send assets from an email or calendar application to a project space. A feature menu 901 includes various features for interacting with email such as a reply feature, reply all, forward, delete, and the like. Feature 903 represents a feature for adding an email to a project space.

Similarly, feature menu 905 represents a feature menu that may be countered in a calendar application or module. The features include actions such as a reply feature, forward, accept, reject, and the like. Feature menu 905 also includes a feature 907 for adding a calendar item to a feature space. Hovering over or selecting the feature 907 may result in a sub-menu 909 for selecting the target project space. Finally, FIG. 9 includes a view 911 of an activity feed related to a project space. As an example, an email 913 has been added to the space, as well as a calendar item.

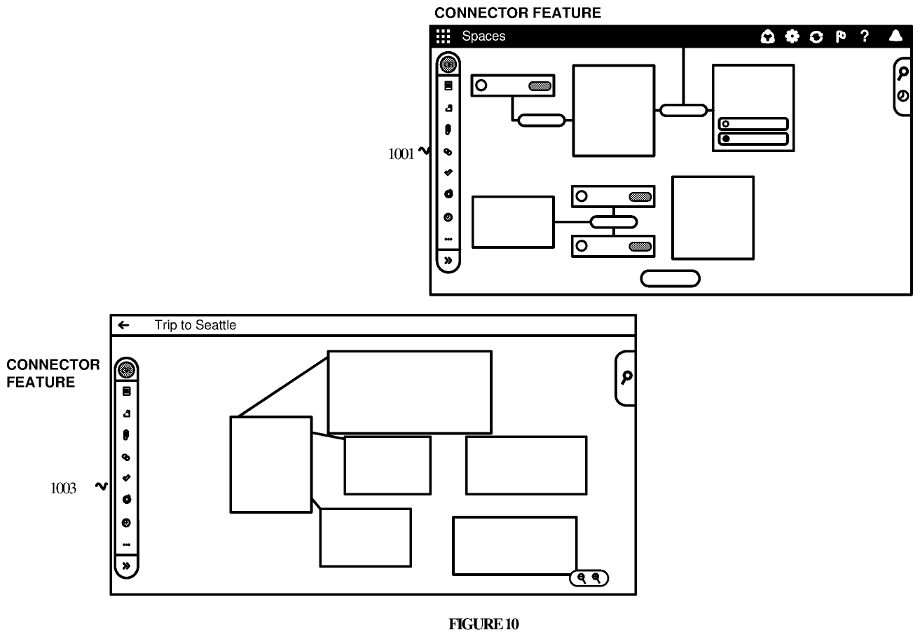

FIG. 10 illustrates two views 1001 and 1003 of a connector feature that allows assets on a canvas to be linked to convey a relationship between two items. That relation can then be leveraged by other tools either within the “spaces” application environment or within other environments.

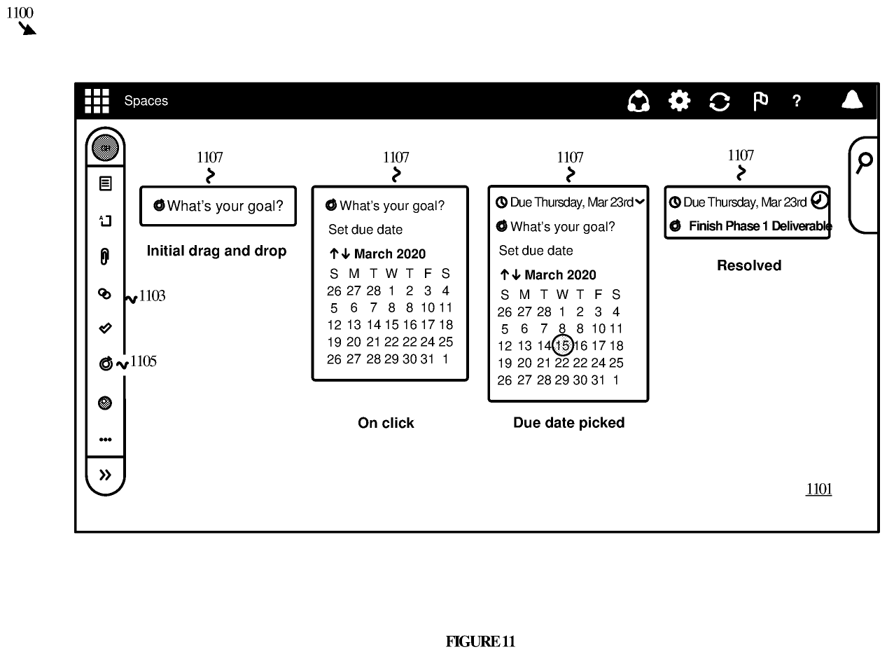

FIG. 11 an application environment that includes a canvas 1101 and a toolbar 1103 for adding items to the canvas. The toolbar includes a control 1105 for creating a goal. The goal item 1107 (or object) may be configured in a series of steps including naming the goal, setting a due date for the goal, and—if completed—marking the goal as resolved.

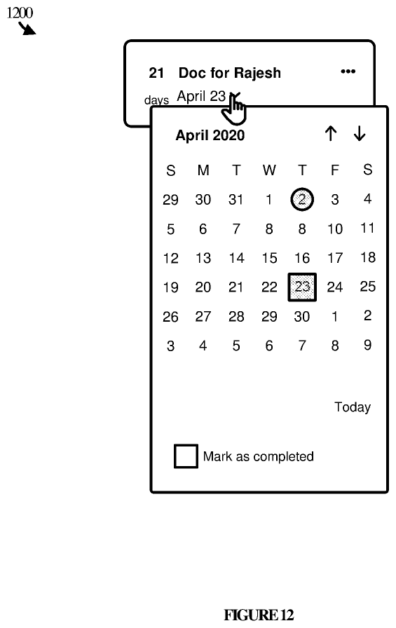

FIG. 12 illustrates another example 1200 of a goal item. In this example, the user can set the deadline and a counter is provided that shows the user how many days are left until the deadline (e.g. 21 days).

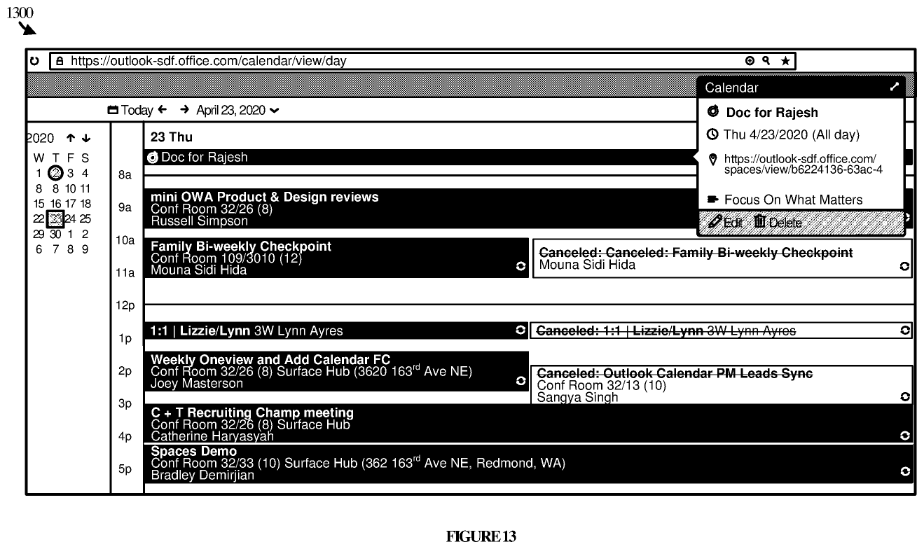

FIG. 13 illustrates a day view 1300 in a calendar application environment. In this example, the goal from FIG. 12 is represented as an all-day appointment on April 23^{rd}.

Referring back to FIG. 3, computing device 301 is representative of any device or collection of devices in which the various application environments, processes, programs, services, and scenarios disclosed herein may be implemented. Examples of computing device 301 include, but are not limited to, mobile phones, tablets, laptops, desktops, watches and other wearable devices, and Internet of Things (IoT) devices. Some or all aspects of the various processes, programs, services, and scenarios disclosed herein may also be implemented on server computers, cloud computing platforms, and data center equipment, as well as any other type of physical or virtual server machine, container, and any variation or combination thereof.

Computing device 301 may be implemented as a single apparatus, system, or device or may be implemented in a distributed manner as multiple apparatuses, systems, or devices. Computing device 301 includes, but is not limited to, processing system 308, storage system 303, software 305, communication interface system 307, and user interface system 309. Processing system 308 is operatively coupled with storage system 303, communication interface system 307, and user interface system 309.

Processing system 308 loads and executes software 305 from storage system 303. Software 305 includes and implements process 306, which is representative of the processes discussed with respect to the preceding Figures. When executed by processing system 308 to enhance the user experience with respect enhanced application environments, software 305 directs processing system 308 to operate as described herein for at least the various processes, operational scenarios, and sequences discussed in the foregoing implementations. Computing device 301 may optionally include additional devices, features, or functionality not discussed for purposes of brevity.

Referring still to FIG. 3, processing system 308 may comprise a micro-processor and other circuitry that retrieves and executes software 305 from storage system 303. Processing system 308 may be implemented within a single processing device but may also be distributed across multiple processing devices or sub-systems that cooperate in executing program instructions. Examples of processing system 308 include general purpose central processing units, graphical processing units, application specific processors, and logic devices, as well as any other type of processing device, combinations, or variations thereof.

Storage system 303 may comprise any computer readable storage media readable by processing system 308 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 303 may also include computer readable communication media over which at least some of software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 308 or possibly other systems.

Software 305 (including process 306) may be implemented in program instructions and among other functions may, when executed by processing system 308, direct processing system 308 to operate as described with respect to the various operational scenarios, sequences, and processes illustrated herein. For example, software 305 may include program instructions for implementing a process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 305 may include additional processes, programs, or components, such as operating system software, virtualization software, or other application software. Software 305 may also comprise firmware or some other form of machine-readable processing instructions executable by processing system 308.

In general, software 305 may, when loaded into processing system 308 and executed, transform a suitable apparatus, system, or device (of which computing device 301 is representative) overall from a general-purpose computing system into a special-purpose computing system customized to provide enhanced application environments. Indeed, encoding software 305 on storage system 303 may transform the physical structure of storage system 303. The specific transformation of the physical structure may depend on various factors in different implementations of this description. Examples of such factors may include, but are not limited to, the technology used to implement the storage media of storage system 303 and whether the computer-storage media are characterized as primary or secondary storage, as well as other factors.

For example, if the computer readable storage media are implemented as semiconductor-based memory, software 305 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 307 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 301 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

User interface system 309 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here.

User interface system 309 may also include associated user interface software executable by processing system 302 in support of the various user input and output devices discussed above. Separately or in conjunction with each other and other hardware and software elements, the user interface software and user interface devices may support a graphical user interface, a natural user interface, a conversational user interface, or any other type of user interface.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable media that, when executed by the one or more processors, direct the computing apparatus to at least:
display an application environment comprising a canvas on which to organize a collection of items on the canvas that are related to a project space;
display a new item on the canvas comprising a goal associated with the project space;
configure one or more attributes of the new item to be associated with one or more items native to one or more other application environments; and
send one or more requests to express, in the one or more other application environments, an association of the one or more items with the goal.

2. The computing apparatus of claim 2 wherein the one or more requests each include information allowing the one or more items to link back to the new item from within the one or more other application environments.

3. The computing apparatus of claim 2 wherein a first attribute of the attributes comprises a deadline for the goal and wherein a first item, of the one or more items, comprises an event scheduled in a calendar at a date and time of the deadline.

4. The computing apparatus of claim 3 wherein a first request of the one or more requests comprises a request to schedule the event in the calendar in accordance with the date and time of the deadline.

5. The computing apparatus of claim 4 wherein a second attribute of the new item comprises a reference to a one of the collection of items on the canvas, and wherein the wherein the one of the collection of items comprises a link to a document object.

6. The computing apparatus of claim 5 wherein a second request, of the one or more requests, comprises a request to populate the document object with a reference to the goal.

7. The computing apparatus of claim 6 wherein a third attribute of the new item comprises a reference to a different one of the collection of items on the canvas, and wherein the wherein the different one of the collection of items comprises a link to an email object.

8. The computing apparatus of claim 7 wherein a third request, of the one or more requests, comprises a request to associate the email object with the goal.

9. The computing apparatus of claim 8 wherein the program instructions further direct the computing apparatus to search for and display a collection of suggested items to add to the collection of items on the canvas.

10. One or more computer readable storage media having program instructions stored thereon that, when executed by one or more processors, direct a computing apparatus to at least:
display an application environment comprising a canvas on which to organize a collection of items on the canvas that are related to a project;
display a new item on the canvas comprising a goal associated with the project and having attributes associated with one or more items native to one or more other application environments; and
send one or more requests to express, in the one or more other application environments, an association of the one or more items with the goal.

11. The one or more computer readable storage media of claim 10 wherein the one or more requests each include information allowing the one or more items to link back to the new item from within the one or more other application environments.

12. The one or more computer readable storage media of claim 11 wherein the one or more items comprise a calendar event, a document object, and a contact.

13. The one or more computer readable storage media of claim 12 wherein the collection of items on the canvas comprise links to the document object and the contact.

14. The one or more computer readable storage media of claim 12 wherein the program instructions further direct the computing apparatus to display a collection of suggested items to add to the collection of items on the canvas.

15. A method comprising:
a computing apparatus displaying, in an application environment, a canvas on which to organize a collection of items on the canvas that are related to a project;
the computing apparatus displaying a new item on the canvas comprising a goal associated with the project and having attributes associated with one or more items native to one or more other application environments; and
the computing apparatus sending one or more requests to express, in the one or more other application environments, an association of the one or more items with the goal.

16. The method of claim 15 wherein the one or more requests each include information allowing the one or more items to link back to the new item from within the one or more other application environments.

17. The method of claim 16 wherein:
a first attribute of the attributes comprises a deadline for the goal; and
a first item, of the one or more items, comprises an event scheduled in a calendar at a date and time of the deadline; and
a first request of the one or more requests comprises a request to schedule the event in the calendar in accordance with the date and time of the deadline.

18. The method of claim 17 wherein:
a second attribute of the new item comprises a reference to a one of the collection of items on the canvas;
the one of the collection of items comprises a link to a document object; and
a second request, of the one or more requests, comprises a request to populate the document object with a reference to the goal.

19. The method of claim 17 wherein:
a third attribute of the new item comprises a reference to a different one of the collection of items on the canvas;
the different one of the collection of items comprises a link to a contact object; and
a third request, of the one or more requests, comprises a request to associate the contact object with the goal.

20. The method of claim 19 further comprising displaying a collection of suggested items to add to the collection of items on the canvas.
